(19) United States
(12) Patent Application Publication
(10) Pub. No.: US 2010/0323066 A1
(43) Pub. Date: Dec. 23, 2010

(54) Process for Solubilization of Flavor Oils

(76) Inventor: Robert Lawrence Comstock, Singapore (SG)

Correspondence Address: VENABLE, Suite 2100, 2049 Century Park East, Los Angeles, CA, 90067, US

(21) Appl. No.: 12/819,198

(22) Filed: Jun. 19, 2010

Related U.S. Application Data
(63) Continuation-in-part of application No. 12/442,794, filed on Jun. 2, 2009.
(60) Provisional application No. 60/826,766, filed on Sep. 25, 2006.
(60) Provisional application No. 60/828,205, filed on Oct. 4, 2006.

(51) Int. Cl. A23L 2/56; A23L 1/222; A23L 2/60; A23L 1/302

(52) U.S. Cl. 426/72; 426/590; 426/651; 426/548; 426/541

(57) ABSTRACT

The inventive process allows the solubilization of flavor oil in water to produce clear beverages. The amount of emulsifier required for oil solubilization is less than that of oil, and a typical oil to emulsifier ratio is 2:1. A crude emulsion is first generated by high shear mixing of the emulsifier solution and flavor oil. The crude emulsion is then fed into a homogenizer to produce a finer emulsion. The resulting flavor concentrate can then be diluted to produce clear beverages. This process also simplifies the introduction of normally insoluble nutraceuticals, particularly lipophilic ones, into beverages. Compared to microemulsion formulations, this process provides an easy way of formulation customization to different flavors and nutraceuticals.

### CROSS-REFERENCE TO PRIOR APPLICATIONS

The present application is a continuation-in-part application of and claims benefit and priority from application Ser. No. 12/442,794, filed 25 Mar. 2009, which is the U.S. National Phase of, and claims priority from PCT/US2007/066861, filed on Apr. 18, 2007 designating the United States, which in turn was based on and claimed priority from U.S. Provisional Patent Application Nos. 60/826,766 filed Sep. 25, 2006 and 60/828,205 filed Oct. 4, 2006 all of which applications are incorporated herein by reference.

### BACKGROUND OF THE INVENTION

1. Area of the Art

This invention relates to a process that solubilizes essential oils to produce clear beverages.

2. Background

Many flavoring agents in beverage preparation are essential oils that are generally water insoluble. The common flavors such as orange, lemon and grapefruit have limited solubility in water. However, these flavors are well received by the consumers due to desirable aroma and flavor, particularly in beverages.

There are several industrial practices to introduce these oils into water. A major technique is to wash/extract the essential oil with a water-miscible solvent to remove the bulk of water insoluble components. In this washing process, the water soluble or polar components of the oil are extracted and this extract can be used to create clear beverages. However, this process does not preserve the full aroma and flavor of the essential oil, and the “freshness” of flavors such as those provided by citrus oils is reduced. Another common technique used is to formulate the essential oils into microemulsions. These microemulsions comprise about 30% essential oil, 20-50% surfactant with the remainder being food grade solvent such as glycerol, propylene glycol, ethanol or even water. Most of these microemulsions also contain ethoxylated surfactants like polysorbates. The use of polysorbates presents taste as well as regulatory issues. Although microemulsions form spontaneously, the relative amounts of oil, surfactants and solvents are crucial to their formation. Because the composition of a given flavor oil depends on its origin and processing, microemulsions have to be tailored to cater to oil differences. In addition, solid flavor delivery systems have also been developed that allows the dispersion of flavor in beverages. In these systems, hydrocolloids and/or starches are used as carriers. A draw back of these systems is that the flavor loading is limited. For example, U.S. Pat. No. 4,707,367 (Miller et al.) discloses a system where the solids contain an average of only 20% by weight flavor.

With the gaining popularity of functional drinks, nutraceuticals such as Coenzyme Q10, omega-3 fatty acids, vitamins and carotenoids are supplemented in beverages. Many of these nutraceuticals are lipophilic in nature and possess limited water solubility. If the targeted end product is a clear beverage, these nutraceuticals have to be formulated into a water-soluble form before introduction into the beverage.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved process for solubilization of flavor oils.

Our improved process for incorporating flavor oils into clear beverages uses a high pressure homogeniser along with high hydrophilic-lipophilic balance (HLB) emulsifiers to solubilize flavor oils allowing brighter, fresher beverages without washing/extraction or necessary inclusion of cosolvents as is common in the industry. Besides resulting in superior oil solubilization, this process also reduces the amount of emulsifier required to solubilize an oil.

In the process, a single emulsifier or a blend of emulsifiers can be used to achieve optically clear beverages flavored with single fold oils especially citrus flavors such as orange, lemon and lime. Besides single fold oil, this technology also works for flavor bases that comprise mixtures of natural flavor oils and synthetic flavorings.

A wide variety of emulsifiers may be used in the process. The emulsifiers that may be used are summarized in Table 1.

TABLE 1

| Type | Emulsifier Name |
|---|---|
| Ionic | Salts of fatty acids such as myristic acid, palmitic |
| | acid, stearic acid, oleic acid |
| | Monoglyceride ester of diacetyltartaric acid |
| | Diglyceride ester of diacetyltartaric acid |
| | Monoglyceride ester of citric acid and salts thereof |
| | Diglyceride ester of citric acid |
| | Monoglyceride ester of lactic acid |
| | Diglyceride ester of lactic acid |
| | Dioctyl sodium sulfosuccinate |
| | Monoglyceride ester of phosphoric acid |
| | Diglyceride ester of phosphoric acid |
| | Lecithin |
| | Hydoxylated lecithin |
| | Lysolecithin |
| Non ionic | Polysorbates |
| | Sorbitan esters of myristic acid |
| | Sorbitan ester of palmitic acid |
| | Sorbitan ester of stearic acid |
| | Sorbitan ester of oleic acid |
| | Polyglycerol esters of myristic acid |
| | Polyglycerol esters of palmitic acid |
| | Polyglycerol esters of stearic acid |
| | Polyglycerol esters of oleic acid |
| | Monoglyceride esters of myristic acid |
| | Monoglyceride esters of palmitic acid |
| | Monoglyceride esters of stearic acid |
| | Monoglyceride esters of oleic acid |
| | Diglyceride esters of myristic acid |
| | Diglyceride esters of palmitic acid |
| | Diglyceride esters of stearic acid |
| | Diglyceride esters of oleic acid |
| | (ethoxy)ₙ monoglyceride esters of myristic acid* |
| | (ethoxy)ₙ monoglyceride esters of palmitic acid* |
| | (ethoxy)ₙ monoglyceride esters of stearic acid* |
| | (ethoxy)ₙ monoglyceride esters of oleic acid* |
| | (ethoxy)ₙ diglyceride esters of myristic acid* |
| | (ethoxy)ₙ diglyceride esters of palmitic acid* |
| | (ethoxy)ₙ diglyceride esters of stearic acid* |
| | (ethoxy)ₙ diglyceride esters of oleic acid* |
| | Sucrose ester of lauric acid |
| | Sucrose ester of myristic acid |
| | Sucrose ester of palmitic acid |
| | Sucrose ester of stearic acid |
| | Sucrose ester of oleic acid |
| | Propylene glycol ester of lauric acid |
| | Propylene glycol ester of myristic acid |
| | Propylene glycol ester of palmitic acid |
| | Propylene glycol ester of stearic acid |
| | Propylene glycol ester of oleic acid |
| | Modified starches such as sodium octenyl succinate |
| | starch, acetylated distarch phosphate, hydroxypropyl |
| | starch and oxidized starch |

*where n is a whole number from 10 to 30.

This process also allows the addition of tocopherol, butylated hydroxyanisole, butylated hydroxytoluene, rosemary oil or other lipophilic substances to the flavor oil for stabilization. Depending on the oil, common weighting agents such as sucrose acetate isobutyrate, brominated vegetable oil and xanthan gum can also be added to the oil to enhance emulsion stability in the concentrate or beverage.

The first step of the process includes dissolving the emulsifier in water. Any of the emulsifiers (including mixtures thereof) in Table 1 can be used. A combination of solvents, such as propylene glycol, glycerol, benzyl alcohol, triacetin, ethanol and isopropanol, and water may also be used to dissolve the emulsifier. We have discovered that besides the use of cosolvents improved results can be obtained by adding sugars (saccharides) and/or sugar alcohols to the aqueous emulsifier mixture. The following sugars and sugar derivatives have been found to be effective: sucrose, fructose, glucose, sorbitol, xylitol, mannitol, glycerol and mixtures thereof. Emulsifiers can also be dry mixed with sucrose and then dissolved. Depending on the emulsifier/emulsifier system used, heat may be applied to facilitate dissolution. In the next step flavor oil is added to the emulsifier solution and a crude emulsion is generated with high shear mixing. The crude emulsion is fed into a two stage homogenizer and subjected to several cycles of homogenization. The homogenization protocol depends on the flavor oil used. Typically, three cycles at 400 bar is adequate. After homogenization, the emulsion concentrate is diluted to the desired flavor loading in the beverage. Depending on the beverage nature, the beverages may be subjected to pasteurization. Following pasteurization, a clear solution is obtained. For beverages that do not undergo pasteurization, the clarity of the beverage is dependent on the terpene content of the flavor oil. A clear beverage can be obtained if the terpene content of the flavor is less than 75%. Pasteurization serves not only to help clarify the beverage but to sterilize it to prevent spoilage due to growth of microorganisms. Besides pasteurization, filtration and ozonation can also be used to sterilize the beverage.

Sucrose monoesters on their own were found to be excellent emulsifiers for the inventive process. Clear beverages can be obtained when only sucrose esters are employed as emulsifiers. The composition of flavor oils is highly dependent on its origin, species and processing history. Furthermore, blending of oils is common so as to achieve a particular flavor profile. Thus this solubilization process should also be robust as to cater to differences in flavor oils. Due to diversity in the range of sucrose esters in terms of fatty acid chain length and degree of esterification, adjustments in the sucrose ester blend has been found to provide a quick way of customization to different oils and nutraceuticals.

The ratio of flavor oil to emulsifier loading varies with the type of flavor oil used. For an orange flavor base with a terpene content of 75%, the ratio is 2:1 when sucrose monopalmitate is used. At this stage, a nutraceutical may be added together with flavor oil. If the nutraceutical has limited water solubility, the emulsifier loading may be increased to accommodate the increase in oil load so that a clear beverages is still obtained.

The effect of emulsifier and flavor on the loading ratios will be illustrated in the examples. However, adjustment of this ratio may be necessary to achieve clarity depending on the flavor oil or oils or emulsifier used.

In the emulsion concentrate the flavor oil is typically present at a concentration of 3% while the sucrose monopalmitate is present at a concentration of 1.5%. This translates to a flavor oil concentration in the final beverage between 25 and 100 ppm and a sucrose monopalmitate concentration of between 12.5 and 50 ppm.

Depending on the nature of flavor oil, clear beverages may not be obtained after dilution of the flavor concentrate. In such cases, pasteurization was found to ensure the clarity of the beverages. In cases where pasteurization is not permitted, the homogenization protocol can be adjusted to render the beverage clear.

The flavor concentrate obtained after homogenization may be stored for later dilution. Storage can involve the addition of thickeners and stabilizers. Another alternative is to dry the concentrate into a powder. Examples of possible drying techniques are spray drying and freeze drying. Finally, the emulsion concentrate is diluted into the beverage to achieve the desired flavor loading and pasteurized. The pasteurization step clarifies the mixture so that a clear solution is obtained.

### Example 1

This example illustrates the formation of a beverage flavored with an orange flavor base.

The emulsifier used was sucrose monopalmitate with monoester content greater than 90%.

| Step | Actions |
|---|---|
| 1) Dry mix | Dry mix 200 g sucrose and 7.5 g sucrose |
| | monopalmitate |
| 2) Solvent mix | Mix 75 g of propylene glycol and 202.25 g of |
| | water. Heat the mixture to 40° C. to |
| | facilitate subsequent dissolution of sucrose |
| | and sucrose ester. |
| 3) Sucrose/sucrose | Add the dry mix of sucrose and sucrose ester |
| ester dissolution | slowly into the solvent mix using high shear |
| | mixer (Silverson L4R). |
| 4) Oil addition | Add 15 g of orange flavor base to the |
| | mixture from step 3 with high shear for |
| | 10 min (Silverson L4R) |
| 3) Homogenization | Homogenize the emulsion at 400 bar for |
| | 3 cycles through a APV1000 homogenizer. The |
| | concentrate solution will be less cloudy |
| | after homogenization. |
| 4) Addition of | The resultant flavor concentrate is then |
| flavor to | dosed at 0.167% into 12brix sugar solution |
| beverage | to yield an orange flavored beverage that |
| | contains 50 ppm orange oil. Citric acid is |
| | added such that the citric acid loading in |
| | beverage is 0.1%. The resultant beverage |
| | clarity is around 3 FTU (formazine |
| | turbidity units). |
| 5) Pasteurization | The beverage is then pasteurized at 85° C. |
| | for 15 min. The resultant beverage will |
| | register an FTU reading less than 2. |

### Example 2

This example illustrates the formation of a beverage flavored with a lemon flavor base that contains less than 75% terpenes. The emulsifier used was 100% sucrose monopalmitate (monoester content greater than 90%).

| Step | Actions |
|---|---|
| 1) Dry mix | Dry mix 200 g sucrose and 7.5 g sucrose |
| | monopalmitate |
| 2) Solvent mix | Mix 75 g of propylene glycol and 202.25 g of |
| | water. Heat the mixture to 40° C. to |
| | facilitate subsequent dissolution of |
| | sucrose and sucrose ester. |
| 3) Sucrose/sucrose | Add the dry mix of sucrose and sucrose ester |
| ester dissolution | slowly into the solvent mix using high shear |
| | mixer (Silverson L4R) |
| 4) Oil addition | Add 15 g of lemon flavor base to the mixture |
| | from step 3 with high shear for 10 min |
| | (Silverson L4R) |
| 3) Homogenization | Homogenize the emulsion at 400 bar for |
| | 3 cycles through a APV1000 homogenizer. The |
| | concentrate solution will be less cloudy |
| | after homogenization. |
| 4) Addition of | The resultant flavor concentrate is then |
| flavor to | dosed at 0.167% into 12brix sugar solution |
| beverage | to yield an orange flavored beverage that |
| | contains 50 ppm orange oil. Citric acid is |
| | added such that the citric acid loading in |
| | beverage is 0.1%. The resultant beverage |
| | clarity is around 3 FTU. |
| 5) Pasteurization | The beverage is then pasteurized at 85° C. |
| | for 15 min. The resultant beverage will |
| | register an FTU reading less than 2. |

### Example 3

This example shows the use of sucrose monolaurate.

| Step | Actions |
|---|---|
| 1) Dry mix | Dry mix 200 g sucrose and 7.5 g sucrose |
| | monopalmitate |
| 2) Solvent mix | Mix 75 g of propylene glycol and 202.25 g of |
| | water. Heat the mixture to 40° C. to |
| | facilitate subsequent dissolution of sucrose |
| | and sucrose ester. |
| 3) Sucrose/sucrose | Add the dry mix of sucrose and sucrose ester |
| ester dissolution | slowly into the solvent mix using high shear |
| | mixer (Silverson L4R) |
| 4) Oil addition | Add 15 g of grapefruit base to the mixture |
| | from step 3 with high shear for 10 min |
| | (Silverson L4R) |
| 3) Homogenization | Homogenize the emulsion at 400 bar for |
| | 3 cycles through a APV1000 homogenizer. The |
| | concentrate solution will be less cloudy |
| | after homogenization, but will remain unclear. |
| 4) Addition of | The resultant flavor concentrate is then |
| flavor to | dosed at 0.167% into 12brix sugar solution |
| beverage | to yield an orange flavored beverage that |
| | contains 50 ppm orange oil. Citric acid is |
| | added such that the citric acid loading in |
| | beverage is 0.1% . |
| 5) Pasteurization | The beverage is then pasteurized at 85° C. |
| | for 15 min. The resultant beverage will |
| | register an FTU reading less than 2. |

The process is effective with any flavor oil/essential oil including orange oil, lemon oil, clove oil, cinnamon oil, mint oil, banana oil and other such oils well known in the art. In addition a variety of water insoluble, primarily lipophilic, nutraceutical and vitamins can be included in the emulsion concentrate. Tocopherol (vitamin E), carotenoids (beta carotene, other carotenes and xanthophylls) and vitamin D can be readily included in beverages by use of the present invention.

The following describes the presently preferred embodiment of the inventive flavor solubilization process when used to produce 1 kg of flavor emulsion at 3% flavor oil load. Due to the small droplet (or micelle) size that can be achieved, beverages flavored with emulsions produced according to this embodiment appear clear and can provide a more authentic, bright and round taste. It has been observed that the large variety of components contained in flavor oils can require further optimization of the emulsion formulation and processing in order to achieve the desired emulsion and end-product stability.

| Composition | % | grams |
|---|---|---|
| Oil phase | | |
| Flavor oil | 3 | 30.0 |
| Solec K-EML | 0.5 | 5.0 |
| lyso-lecithin | | |
| Water phase | | |
| Habo brand | 1 | 10.0 |
| sucrose | | |
| palmitate | | |
| Monoester P90 | | |
| Propylene glycol | 12 | 120.0 |
| Glycerol | 23.5 | 235.0 |
| Sucrose | 36 | 360.0 |
| Water | 24 | 240.0 |
| Total | 100 | 1,000.0 |

Equipment Required:
1. High-shear mixer (Silverson L4R or equivalent)
2. Two stage high-pressure homogenizer capable of 250 bar (laboratory scale).
3. Malvern Zetasizer Nano-S or equivalent sub-100 nm capable particle size analyzer.

Laboratory Preparation:

Water Phase
1. Sucrose monoester solution:
Mix propylene glycol, glycerol and P90 using a high-shear mixer at 6,000 rpm or higher speed for at least 10 minutes. Make sure that the solution is homogenous and that no P90 lumps remain. The solution can be centrifuged at 4000 rpm for 5-10 minutes to quickly get a clear stock solution.
2. Sucrose solution:
Manual mixing in a hot water bath should be sufficient. Let the sucrose solution cool down before use.
3. The sucrose solution and sucrose monoester stock can be prepared in advance as stock solutions for multiple uses.

Oil Phase

Including: Flavor oil, Solec K-EML, and antioxidants
Dissolve lyso-lecithin into flavor oil. Manual mixing should be sufficient. Addition of an oil soluble antioxidant, such as mixed tocopherols, is possible at this stage.

Mixing Process
1. Add the sucrose solution to the sucrose monoester solution and high-shear mix at 4,000 to 6,000 rpm for 10 minutes.
2. Next, add the oil phase to the above mixture and high-shear mix for another 10 minutes at 4,000 to 6,000 rpm.
3. Homogenize the mixture at 250/50 bar for 3 passes. Take samples after each pass. The pressure or number of passes depends upon the homogenizer efficiency.
4. Let the emulsion de-foam before use. An ultrasonic bath may be used.
5. Confirm the particle size achieved after each homogenization pass. Clear and stable emulsions typically contain micelles smaller than 0.07 μm.

Recommendations & Remarks
Homogenizer efficiencies vary. In order to determine the efficiency of your homogenizer, take samples after each homogenization pass and confirm the micelle size achieved. Clear and stable emulsions typically contain micelles smaller than 0.07 μm with a narrow size distribution. Once the desired micelle size is achieved, no additional homogenization passes are necessary. If the desired micelle size cannot be achieved, higher homogenization pressure or an adjustment of the formulation might be necessary.
Production scale homogenizers typically reduce micelle sizes more efficiently than laboratory models, so lower homogenization pressure and fewer passes might be acceptable in a production environment.
Mixed tocopherols and/or other antioxidants can be added to the flavor oil to enhance oxidation stability. High levels of antioxidants will have an influence on the emulsion behavior and might require an adjustment of the formulation.
Often different flavor oils will require different parameters for optimal performance.
The level of lyso-lecithin should not exceed 50% relative to the P90 as beverage clarity will be impacted. The polarity of the flavor is reciprocal to the optimal lyso-lecithin:P90 ratio and should range from 1:15 to 1:2 (at constant combined concentration). Furthermore, for highly polar (e.g. folded) flavors it might be necessary to increase the total amount of P90 in the emulsion to achieve clarity and stability.
If the micelle size of the emulsion is too large and appears to be reduced only by higher homogenization pressures, the same can be achieved by matching the viscosity of the flavor oil closely to the viscosity of the water phase. Choosing a different sugar (or replacing it with sorbitol) can have a big impact on the viscosity, as well as the amount of glycerol in the emulsion.

The following examples show presently preferred embodiments of the present invention for emulsifying a variety of oils used in foods.

The inventive solubilization process can be used to solubilize Vitamin E. The follow example produces 1 kg of Vitamin E emulsion at 20% oil load. Due to the small droplet (or micelle) size that can be achieved, beverages fortified with this emulsions appear optically clear. Further, the emulsion can be certified Kosher and Halal.

The required ingredients are shown in the following table (Table 3)

TABLE 3

| Composition | % | grams |
|---|---|---|
| Oil phase | | |
| Tocopherol | 20 | 200 |
| acetate oil | | |
| Solec K-EML | 2 | 20 |
| lysolecithin | | |
| Habo brand | 8 | 80 |
| sucrose | | |
| palmitate | | |
| Monoester P90 | | |
| Glycerol | 28 | 280 |
| Invert Syrup | | |
| Solution | | |
| Sucrose | 26.9 | 269 |
| Water | 15.1 | 151 |
| Citric Acid | 0.0269 | 0.269 |

The Required Equipment is:
1. High-shear mixer (Silverson L4R or equivalent)
2. Two stage high pressure homogenizer capable of 800 bar
3. Malvern Zetasizer Nano-S or equivalent sub-100 nm capable particle size analyzer.

Ingredient preparation:
Purchase inverted sugar, or prepare with the following: Dissolve the sucrose and citric acid in water and bring the solution to boil. Keep the solution boiling for 20 minutes; maintain initial volume of solution by topping up the water that has evaporated. Let the solution cool down before use.

Mixing
Mix the invert syrup solution, the P90 and the Solec K-EML with the glycerol in the Silverson high shear mixer for 10 minutes at full speed.
Add the Tocopherol Acetate and mix for 5 minutes at full speed and 5 minutes at half speed.

Homogenization:
After mixing, homogenize the emulsion at 800/160 bar for up to 6 passes.
Micelle size measurement
Measure the micelle size after each homogenization pass. Clear and stable emulsions typically consist of micelles smaller than 0.06 μm.

The following embodiment describes the emulsion preparation protocol to produce 1 kg of a 2.5% Beta Carotene emulsion. Due to the small droplet (or micelle) size that can be achieved, beverages fortified with such beta carotene emulsions have a natural color and appear clear. The perceived color and intensity can be adjusted to some extent via the adjustment of the usage level of the emulsion in the end product matrix. The composition is shown in Table 4.

TABLE 4

| Composition | % | grams |
|---|---|---|
| Oil phase | | |
| 30% beta | 8.3 | 83 |
| carotene in | | |
| sunflower oil | | |
| dispersion | | |
| Lecithin phase | | |
| Solec K-EML | 5.0 | 50 |
| lyso-lecithin | | |
| Mixed | 0.5 | 5 |
| tocopherol | | |
| Water phase | | |
| Habo brand | 5.0 | 50 |
| sucrose | | |
| palmitate | | |
| Monoester P90 | | |
| Inverted syrup | 81.2 | 812 |
| (66%) or | | |
| sorbitol (70%) | | |
| Total | 100 | 1000 |

The required equipment is:
1. High-shear mixer (Silverson L4R or equivalent)
2. Two stage high pressure homogenizer capable of 800 bar
3. Malvern Zetasizer Nano-S or equivalent sub-100 nm capable particle size analyzer.

Water Phase:

Inverted Sugar Syrup or Sorbitol
Purchase inverted sugar solution or produce it by boiling sugar and water until all sugar is dissolved, then adding 0.1% of citric acid and continue boiling for 20-30 min. Add additional water to maintain consistent volume. Let the sucrose solution cool down before use. Sorbitol can be used instead of inverted sugar syrup, and dilution from 70% to 66% can be used to reduce viscosity to a manageable level.
The sucrose solution can be prepared in advance as stock solutions for multiple uses.

Lecithin Phase:

Including: Solec K-EML, mixed tocopherols.

Manually mix the tocopherols with Solec K-EML.

Oil Phase:
Dissolve the beta-carotene crystals in sunflower oil completely by heating at 140-150° C. for about 15-20 min while mixing.

Mixing Process
1. Add P90 powder to the inverted sugar syrup using high-shear mixing at 4,000 to 6,000 rpm for about 10 minutes until all powder is well mixed with syrup. This mixture should not contain any visible solids and will be viscous and sticky. Additional mixing can be used if lumps are still visible. Add the lecithin phase into the water phase after P90 addition and continue to mix for an additional 5 minutes. The mixture should now have a low viscosity.
2. Pour the hot oil phase mixture into the P90 in syrup mixture (that is still in the high shear mixer and at around 40-50° C.), and continue to high-shear mix for another 10 min. Note: If the beta-carotene containing phase is allowed to cool down too much the beta carotene will begin to crystallize and the emulsion will not be clear or stable.
3. Homogenize the mixture at 800/160 bar for 6 passes, taking a small sample for particle size analysis following each pass.
4. Let the emulsion de-foam before use. An ultrasonic bath can be used.
5. Confirm the particle sizes achieved after each homogenization pass. Clear and stable beta carotene emulsions typically contain micelles around 0.05 μm. Reducing the amount of P90 and lyso lecithin will increase the particle size and create a more orange color.

The above and the following example shows that an extremely wide variety of edible oils can be emulsified using the various embodiments of the process. The following example illustrates an emulsion preparation protocol to produce 1 kg of a 20% Pasilla oil emulsion. Due to the small droplet (or micelle) size that can be achieved, beverages fortified with this Pasilla emulsion have a natural color and appear clear. The perceived color and intensity can be adjusted to some extent via the adjustment of the usage level of the emulsion in the end product matrix. Further refinement and adjustment of the emulsion formulation and processing conditions may be required to achieve desired stability of the emulsion as a concentrate and as applied in the desired end product formulation depending upon user's requirements. The composition is shown in Table 5.

TABLE 5

| Composition | % | grams |
|---|---|---|
| Oil phase | | |
| Pasilla Oil | 20 | 200 |
| Lecithin phase | | |
| Solec A | 2.0 | 20 |
| hydroxylated | | |
| lyso-lecithin | | |
| Mixed | 1.0 | 10 |
| tocopherol | | |
| Water phase | | |
| Habo brand | 8.0 | 80 |
| sucrose | | |
| palmitate | | |
| Monoester P90 | | |
| Propylene glycol | 5.0 | 50 |
| Glycerol | 15.0 | 150 |
| Sorbitol (66%) | 50.0 | 500 |
| Total | 100 | 1000 |

The Required Equipment is:
1. High-shear mixer (Silverson L4R or equivalent)
2. Two stage high pressure homogenizer capable of 800 bar
3. Malvern Zetasizer Nano-S or equivalent sub-100 nm capable particle size analyzer.

Water Phase

Including: Propylene glycol, glycerol and sorbitol

Dilute sorbitol from 70% to 66% can reduce viscosity to a manageable level.

Mix the three solvents well.

Lecithin Phase

Including: Solec A, mixed tocopherols.

Manually mix the tocopherols with Solec A.

Mixing Process
1. Add lecithin phase in to the water phase and mix well, followed by the addition of P90 using high-shear mixing at 4,000 to 6,000 rpm for about 10 minutes until all powder is well mixed with syrup. This mixture should not contain any visible solids. Additional mixing or higher mixing speed can be used if lumps are still visible.
2. Pour the oil into the surfactant water phase mixture (that is still in the high shear mixer), and continue to high-shear mix for another 10 min.
3. Homogenize the mixture at 800/160 bar for 6 passes, taking a small sample for particle size analysis following each pass.
4. Let the emulsion de-foam before use. An ultrasonic bath or centrifuge can be used.
5. Confirm the particle sizes achieved after each homogenization pass. Clear and stable emulsions typically contain micelles less than 100 nm, for Pasilla emulsions, are around 50-60 nm. Reducing the amount of P90 and lyso lecithin will increase the particle size.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. A process for solubilizing flavor oils to produce clear beverages comprising the steps of:
mixing flavor oil into an aqueous solution of emulsifier containing at least one sucrose ester with a high shear mixer to form a crude emulsion;
homogenizing the crude emulsion to form a flavor concentrate; and
diluting the flavor concentrate into a beverage.

2. The process according to claim 1, wherein the ratio of flavor oil to emulsifier is 2:1 in the flavor concentrate.

3. The process according to claim 1 further comprising the step pasteurizing the beverage to clarify it.

4. The process according to claim 1 further comprising a step of dry mixing sucrose with sucrose ester prior to the step of mixing.

5. The process according to claim 1, wherein the emulsifier comprises a mixture of emulsifiers.

6. The process according to claim 1, wherein the flavor concentrate is stored after the step of homogenizing and prior to the step of diluting.

7. The process according to claim 6, wherein storing the flavor concentrate further comprises adding thickeners and/or stabilizers.

8. The process according to claim 6, wherein storing the flavor concentrate further comprises drying the flavor concentrate to form a powder.

9. The process according to claim 1, wherein the amount of emulsifier in the crude emulsion ranges from 0.1 to 30% weight by volume.

10. The process according to claim 1, wherein the aqueous solution further contains one or more water miscible solvents selected from the group consisting of propylene glycol, glycerol, benzyl alcohol, triacetin, ethanol and isopropanol.

11. The process according to claim 1, wherein the aqueous solution further contains saccharides and/or sugar alcohols selected from the group consisting of sucrose, fructose, glucose, sorbitol, xylitol, mannitol, glycerol and mixtures thereof.

12. The process according to claim 1, wherein the flavor oil in the crude emulsion ranges from 0.2 to 30% weight by volume.

13. The process according to claim 1, wherein the beverage contains 0.005 to 0.02% weight by weight flavor oil.

14. The process according to claim 1, wherein the pH of the beverage ranges from 2 to 8.

15. The process according to claim 1, wherein the flavor oil is selected from the group consisting of lemon, berry, orange, grapefruit, tangerine, lime, kumquat, mandarin, bergamot and mixtures thereof.

16. The process according to claim 15, wherein the flavor oil also contains synthetic flavorings.

17. The process according to claim 1, wherein the flavor concentrate contains a lipophilic antioxidant selected from the group consisting of tocopherol, butylated hydroxyanisole, butylated hydroxytoluene, rosemary oil and mixtures thereof.

18. The process according to claim 1, wherein the flavor concentrate further contains a weighting agent.

19. The process according to claim 18, wherein the weighting agent is selected from the group consisting of sucrose acetate isobutyrate, brominated vegetable oil and xanthan gum.

20. The process according to claim 1, wherein the flavor concentrate further contains a nutraceutical.

21. The process according to claim 20, wherein the nutraceutical is selected from the group consisting of coenzyme Q10, omega-3 fatty acids, vitamins and carotenoids.

22. The process according to claim 1, wherein the beverage is sterilized by a process selected from the group consisting of ozonation, filtration and pasteurization.
